(19) United States
(12) Patent Application Publication
(10) Pub. No.: US 2016/0162482 A1
(43) Pub. Date: Jun. 9, 2016

(54) AUTOMATED IMAGE RANKING

(71) Applicant: Yahoo!, Inc., Sunnyvale, CA (US)

(72) Inventors: Gerry Pesavento, Orinda, CA (US); Rajiv Vaidyanathan, San Francisco, CA (US); Nilesh Gattani, San Francisco, CA (US); Amol Deshmukh, San Francisco, CA (US); Frank Zijie Liu, Corvallis, OR (US)

(21) Appl. No.: 14/560,252

(22) Filed: Dec. 4, 2014

(51) Int. Cl. G06F 17/30; G06K 9/46

(52) U.S. Cl. CPC G06F 17/3028; G06K 9/46; G06F 17/30268

(57) ABSTRACT

A first image, associated with a first tag, and/or other images may be presented to a user. A user behavior of the user in regards to the first image may reduce or increase a quality score of the first image. A quality metric of the first image may be determined, and may be used to decrease or increase the quality score of the first image. A rank may be assigned to the first image based upon the modified quality score. The first image may be provided to users based upon the rank.

### BACKGROUND

Many users may use search engines to locate interesting or relevant images. Such images may have been tagged with tags that are indicative of the subject matter of the images. Unfortunately, the user may receive uninteresting and/or irrelevant images as search results, if the images are not accurately tagged and/or are tagged too broadly. Providing a plethora of undesirable images may waste bandwidth, computing resources, and/or user interface display area such as of a mobile device with a relatively smaller screen.

### SUMMARY

In accordance with the present disclosure, a first subject matter of a first image may be identified. A first tag may be associated with the first subject matter. The first tag may be assigned to the first image. In an example, a first automatic tag may be generated for the first image based upon the subject matter of the first image. The first tag may be based upon the first automatic tag.

A first rank may be assigned to the first image associated with the first tag. A second rank may be assigned to a second image associated with the first tag. Responsive to receiving a first search from a client device, the first image and the second image may be provided to the client device, where the first search corresponds to the first tag. A quality score for the first image and/or the second image may be generated based upon a user behavior and/or a quality metric. The user behavior may comprise at least one of a selection of the first image, a purchase of the first image, a rating of the first image, a bookmark of the first image, an identification of the first image as inappropriate, or an identification of the first image as offensive. In an example, the quality metric may be based upon a photo quality rating, a tag quality, a price, a sponsorship, and/or a proprietary metric of the first image and/or the second image. In an example, the quality metric may be based upon a time elapsed from receipt of the first image and/or the second image to a current time.

A user associated with the client device may be identified. Responsive to the user being a registered photographer, a first quality score may be assigned to the first image. Responsive to the user not being a registered photographer, a second quality score may be assigned to the first image. The first quality score may be higher than the second quality score. At least one of the first rank or the second rank may be altered based upon the quality score.

Responsive to determining the quality score of the first image, the ranking of the first image may be altered relative to the second image based upon the quality score. Responsive to determining the quality score of the second image, the ranking of the second image may be retrained or may be altered, such as to an increased second rank, or a reduced second rank. In an example, a second search, corresponding to the first tag, may be received. The first image may be provided based upon the first rank, but the second image may not be provided based upon the reduced second rank, as a search result for the second search.

A third search corresponding to the first tag and a second tag may be performed. Responsive to receiving the third search, the ranking of the first image may be increased relative to the second image based upon the first image being associated with the first tag and the second tag and the second image being associated with the first tag but not the second tag.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method of automated image search ranking.

FIG. 5A is a component block diagram illustrating an example system for ranking images, where a first rank is altered.

FIG. 5B is a component block diagram illustrating an example system for ranking images, where a second rank is altered.

FIG. 5C is a component block diagram illustrating an example system for ranking images, where a first rank is assigned based on a tag association.

FIG. 6A is a component block diagram illustrating an example system for ranking images using user behavior to generate a quality score for a first image.

FIG. 6B is a component block diagram illustrating an example system for ranking images using user behavior to generate a quality score for a first image.

FIG. 6C is a component block diagram illustrating an example system for ranking images using user behavior to generate a quality score for a first image.

FIG. 6D is a component block diagram illustrating an example system for ranking images using user behavior to generate a quality score for a first image.

FIG. 7 is a component block diagram illustrating an example system for ranking images based upon an identification of user behavior of a user.

FIG. 8 is an illustration of a scenario featuring an example nontransitory memory device in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

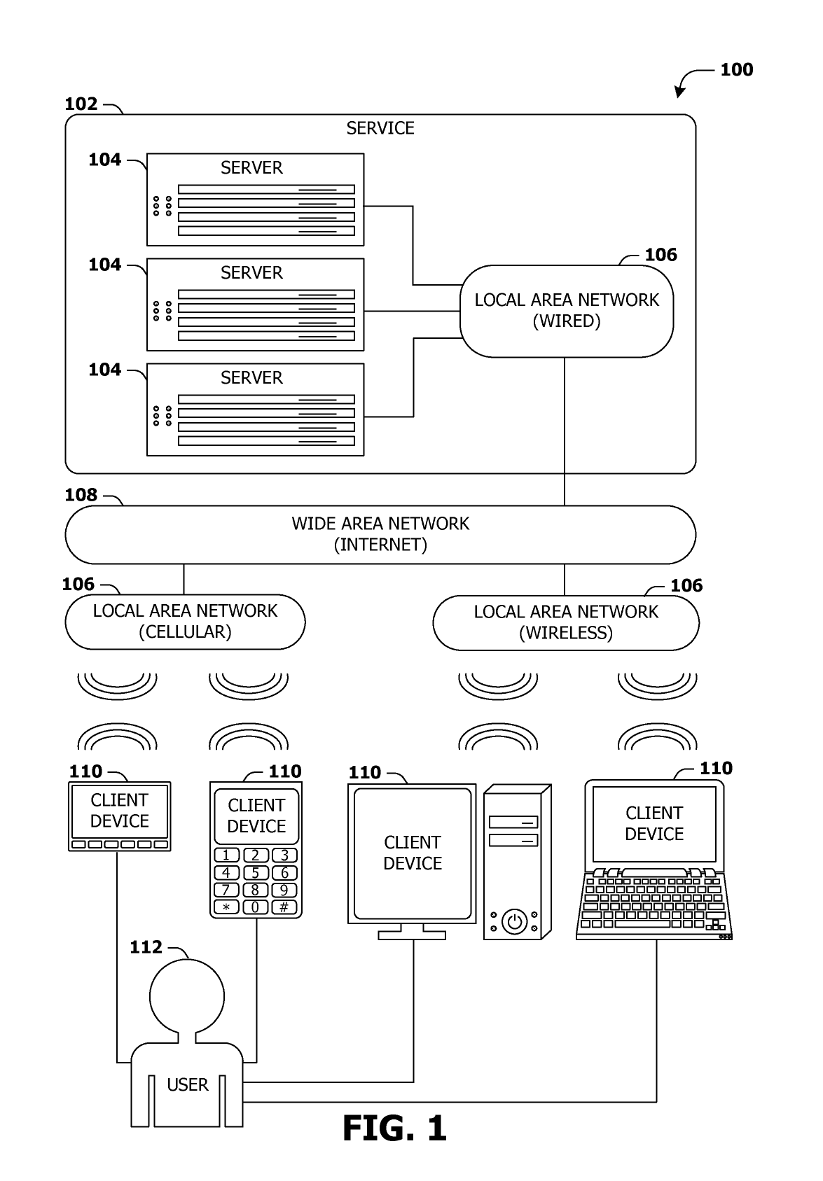

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

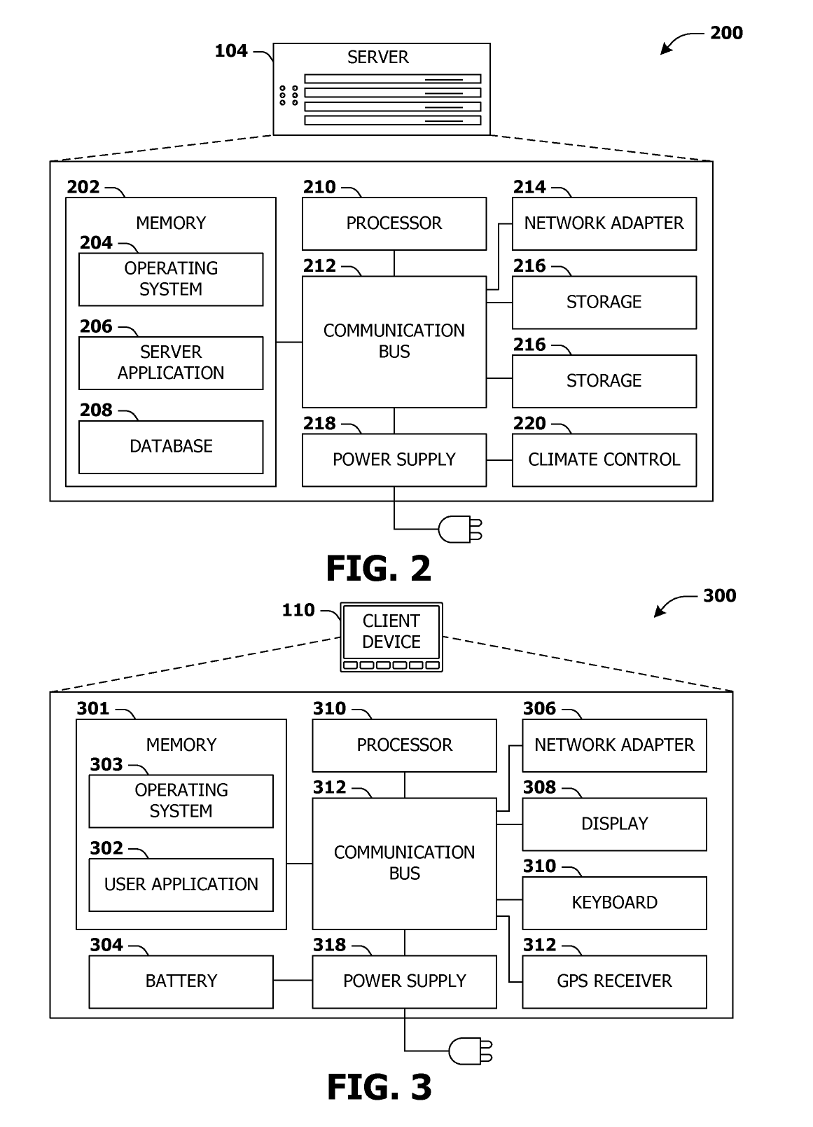

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 210 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 310, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110. Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

2. Presented Techniques

One or more systems and/or techniques for automated image search ranking are provided herein. Images may be tagged with tags that are indicative of the subject matter of the images. Without accurate tagging, a mixture of high and low quality images may be presented to the user (e.g., the tags may be generic, causing an image to be presented in response to many searches, when it is relevant to merely a few of the searches). Thus, the user may be provided with a plethora of undesirable images, which may waste bandwidth, computing resources, and/or user interface display area, such as of a mobile device with a relatively smaller screen. As provided herein, images may be automatically tagged, ranked, and/or re-ranked so that relevant and/or interesting images may be provided to users, which may mitigate bandwidth, computing resources, and/or user interface display area that may otherwise be consumed in providing undesirable images to users (e.g., a user may waste computing resources to perform multiple searches until relevant images are obtained).

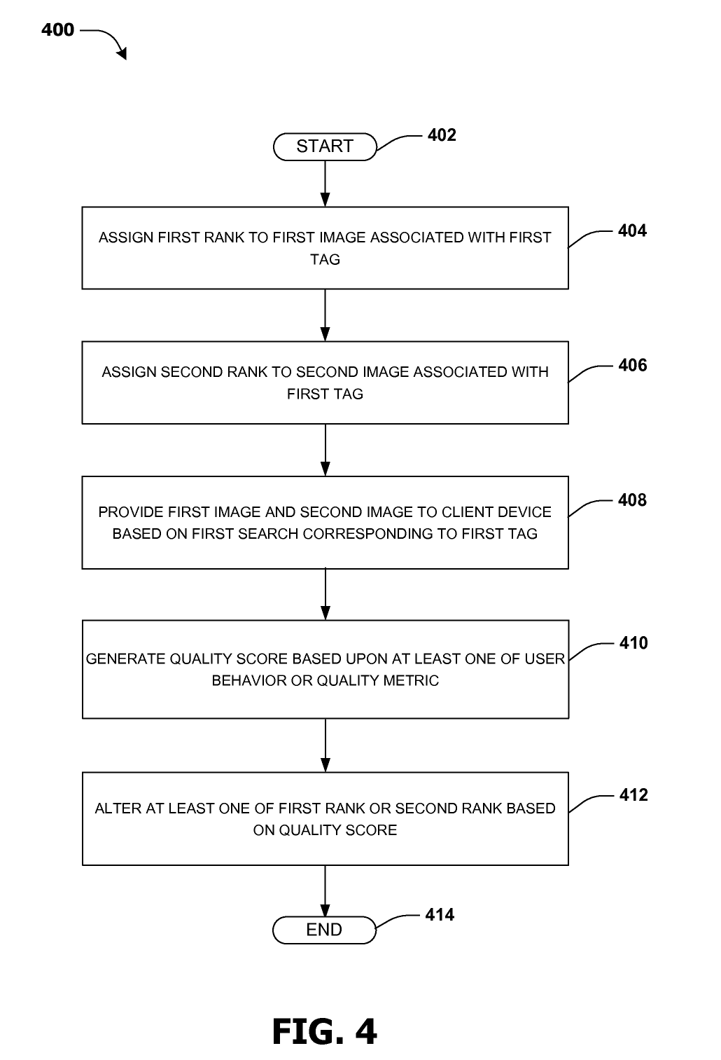

An embodiment of automated image search ranking is illustrated by an example method 400 of FIG. 4. At 402, the method starts. A first user on a first client device may upload a first image associated with a first subject matter to a website. The first user may assign a first tag, associated with the first subject matter, to the first image (e.g., a first tag of “flower” may be assigned to a garden image). In an example, a first automatic tag for the first image may be generated by an automated tag component based upon the subject matter of the first image. The first tag may comprise or may be augmented based upon the first automatic tag. Upon upload, the first image may be assigned an initial quality score, which may be subsequently changed.

A second user on a second client device may upload a second image associated with the first subject matter to the website. The second user may be a same or different user than the first user. The second client device may be a same or different client device than the first client device. The second user may assign the first tag, associated with the first subject matter, to the second image (e.g., the first tag “flower” may be assigned to a wedding photo depicting a bouquet of flows). In an example, a second automatic tag for the second image may be generated by the automated tag component based upon the subject matter of the second image. Upon upload, the second image may be assigned a second initial quality score, which may be subsequently changed.

At 404, a first rank may be assigned to the first image associated with the first tag. The first rank may be assigned based upon the initial quality score. The first rank may be used to order images for display to a user on a client device responsive to a search. The user may be a same or different user than the first user and/or the second user. The client device may be a same or different client device than the first client device and/or the second client device. The rank associated with an image may determine the order in which the image is displayed relative to other images displayed to the user on the client device. At 406, a second rank may be assigned to the second image that is associated with the first tag. The second rank may be assigned to the second image based upon the second initial quality score. The second rank may be associated with the order in which images are displayed to the user on the client device.

At 408, responsive to receiving a first search corresponding to the first tag, the first image and the second image may be provided as search results. The first image, having been assigned the first rank, may be displayed in a first space (e.g., a first visually prominent location on a search results page) on a display of the client device. The second image, having been assigned the second rank, may be displayed in a second space (e.g., a second visually prominent location on the search results page).

At 410, a quality score may be generated for the first image and/or the second image based upon a user behavior (e.g., of a user that submitted the first search) and/or a quality metric of the first image and/or the second image. In an example, the user behavior may comprise a selection of the first image and/or the second image by the user on the client device. In an example, the selection of the first image (e.g., enlarging the first image, directing a cursor over the first image and clicking, etc.), may increase the quality score of the first image. For example, the quality score associated with the first image may increase by a first threshold amount (e.g., 10%) responsive to the selection of the first image. In another example, the quality score associated with the selection of the first image may be assigned by the owner and/or operator of the webpage.

In an example, the user behavior may comprise a purchase of the first image and/or the second image by the user on the client device. In an example, the purchase of the first image may increase the quality score of the first image. For example, the quality score associated with the first image may increase by a second threshold amount (e.g., 60%) responsive to the purchase of the first image. In another example, the quality score associated with the purchase of the first image may be assigned by the owner and/or operator of the webpage.

In an example, the user behavior comprises a rating of the first image and/or the second image by the user on the client device. In an example, the rating may comprise determining and assigning an interestingness score to the first image. The interestingness score may comprise a measure that assesses a relative importance of a statistical result. The interestingness score may comprise a standardized value that allows different statistical results (e.g., a number of positive and/or negative comments about the first image, a number of discussions about the first image, etc.) to be compared on one scale. In an example, the interestingness score may comprise a first scale (e.g., the first scale may be from 0 to 1), or any other scale. The interestingness score may incorporate information associated with the first image, such as positive ratings by users, comments by users, number of views by users, discussion about the first image by users, etc. In an example, a positive rating may comprise an interestingness score over a threshold (e.g., about 0.5) on the first scale (e.g., about 0 to 1) and a negative rating may comprise an interestingness score below the threshold on the first scale.

An approval option (e.g., a like icon, a thumbs up, etc.) may be selected by the user to indicate a positive response. The selection of the approval option may be integrated into the interestingness score. For example, the quality score associated with the first image may increase by a first score (e.g. by about 0.8 to about 1.2) on a second scale (e.g. the second scale may be about 0 to 20) responsive to the interestingness score being over the threshold. In an example, the quality score associated with the first image may increase by a second score (.e.g., the second score may be about 8 to about 10) on a third scale (e.g., the third scale may be about 0 to 20) responsive to the positive rating, where the positive rating is generated on a secondary website.

A disapproval option (e.g., a dislike icon, a thumbs down, etc.) may be selected by the user to indicate a negative response. The negative response may be integrated into the interestingness score. For example, the quality score associated with the first image may be decreased by a third score (e.g., the third score may be about 0.8 to about 1.2) on a fourth scale (e.g., the fourth scale may be about 0 to 20) responsive to the interestingness score being below about the threshold. In an example, the quality score associated with the first image may decrease by a fourth score (e.g., the fourth score may be about 8 to about 10) on a fifth scale (.e.g., the fifth scale may be about 0 to 20) responsive to the negative response, where the negative response is generated on the secondary website. In an example, the quality score associated with the negative rating and/or the positive rating may be assigned by the owner and/or operator of the webpage.

In an example, the user behavior may comprise a bookmark of the first image and/or the second image by the user on the client device. The user may bookmark the first image and/or the second image for future views and/or a later purchase. In an example, the bookmark of the first image may increase the quality score of the first image. For example, the quality score associated with the first image may increase by a fifth score (e.g., the fifth score may be between about 2 to about 6) responsive to the bookmark of the first image. In another example, the quality score associated with the bookmark of the first image may be assigned by the owner and/or operator of the webpage.

In an example, the user behavior may comprise an identification of the first image and/or the second image as inappropriate by the user on the client device. In an example, the identification of the first image as inappropriate may decrease the quality score of the first image. For example, the quality score associated with the first image may decrease by a sixth score (e.g., the sixth score may be between about 8 to about 12) on a sixth scale (e.g., the sixth scale may be about 0 to 20) responsive to the identification of the first image as inappropriate. The user may be limited to identifying one image, or any other number of images, as inappropriate per day. In an example, the quality score associated with the identification of the first image as inappropriate may be assigned by the owner and/or operator of the webpage.

In an example, the user behavior may comprise an identification of the first image and/or the second image as offensive by the user on the client device. In an example, the identification of the first image as offensive may decrease the quality score of the first image. For example, the quality score associated with the first image may decrease by a seventh score (e.g., the seventh score may be about 0 to about 5) on a seventh scale (e.g., the seventh scale may be about 0 to 20) responsive to the identification of the first image as offensive. The user may be limited to identifying one image, or any other number of images, as offensive per day. In another example, the quality score associated with the identification of the first image as offensive may be assigned by the owner and/or operator of the webpage.

In an example, where the user is identified as a registered photographer, the quality score associated with the user actions may be higher than where the user is not identified as a registered photographer. In an example, where the user is identified as having a successful history (e.g., the user has sold a large number of photos), the quality score associated with the user actions may be higher than where the user is not identified as having a successful history. The user being identified as the registered photographer, or as having the successful history, may influence the degree in which the user's actions influence the quality score (e.g., the user identified as the registered photographer may have a greater influence than the user not identified as the registered photographer).

In an example, the quality metric may comprise a photo quality rating. The photo quality rating may be determined by a photo quality detector. The photo quality detector may comprise a mechanism to determine clarity, definition (e.g., dots per square inch (DPI), pixel count, etc.), etc., of the first image and/or the second image.

The photo quality detector may comprise a mechanism to automatically infer an image's aesthetic beauty. The automatic inference may determine the aesthetic beauty of the first image and/or the second image by using the pixels of the first image and/or the second image. The photo quality detector may access a database comprising underlying characteristics of high quality and/or pleasing images and low quality and/or unpleasing images. The photo quality detector may determine whether the first image and/or the second image has the underlying characteristics of a high quality and/or pleasing image or a low quality and/or unpleasing image. The first image and/or the second image having the underlying characteristics of a high quality and/or pleasing image may be determined to be aesthetically beautiful. The first image and/or the second image having the underlying characteristics of a low quality and/or unpleasing image may be determined to be aesthetically not beautiful.

The photo quality detector may comprise a subject mask extractor (e.g., a foreground-background extractor that may distinguish a foreground in an image from a background). The subject mask extractor may employ superpixels, keypoint detection, global color uniqueness, and/or k-means clustering (e.g., the k-means clustering may provide a binary mask to separate foreground pixels from background pixels). The subject mask extractor, using an algorithm, may extract features specific to the foreground and/or background of the first image and/or second image. The differentiation of the foreground and the background may allow for a better assessment of the aesthetic beauty of the first image and/or the second image.

The quality detector may comprise a deep convolutional neural network. The deep convolutional neural network may output an output score. Using the output score, deep features may be condensed into an aesthetic score. The aesthetic score may be added to an aesthetic model as its own feature. The aesthetic model may be indicative of the aesthetic beauty of the first image and/or the second image (e.g., the first image may be aesthetically beautiful and the second image may be aesthetically not beautiful).

For example, the quality score associated with the first image may increase or decrease by a first metric score (e.g. the first metric score may be about 0 to about 5) on a first metric scale (e.g., the first metric scale may be about 0 to 20) proportionally with the photo quality rating of the first image (e.g., a high photo quality rating may increase the quality score by 5, and a poor photo quality rating may decrease the quality score by 5). For example, the high photo quality rating may be determined where the first image is very clear (e.g., not blurry and has a high pixel count to a size of the first image ratio) and/or is determined to be aesthetically beautiful (e.g., as determined by the photo quality detector). For example, the low photo quality rating may be determined where the first image is unclear (e.g., blurry and has a low pixel count to a size of the first image ratio) or is determined to be aesthetically not beautiful (e.g., as determined by the photo quality detector). In an example, the quality score associated with the high photo quality rating and/or the low photo quality rating may be assigned by the owner and/or operator of the webpage.

In an example, the quality metric may comprise a tag quality rating. The tag quality rating may be determined by a tag quality detector. The tag quality detector may comprise a mechanism to determine an accuracy of the first tag's association with the first subject matter and/or the association of the first image and/or the second image with the first subject matter. For example, if the first subject matter is dogs (e.g., the first image depicts a dog), the first tag may be determined to be accurate, and thus have a high tag quality rating, where the first tag is one of dog, canine, man's best friend, etc. For example, if the first subject matter is horses (e.g., the first image depicts a horse), the first tag may be determined to be inaccurate, and thus have a low tag quality rating, where the first tag is dog, canine, man's best friend, etc. For example, if the first subject matter is cats (e.g., the first image depicts a cat), the first tag may be determined to be partially accurate, and thus have a median tag quality rating, where the first tag is cat, canine, feline, man's best friend, etc. In an example, responsive to the tag quality detector having a low tag quality rating, tags associated with the image having the low tag quality may be reviewed and altered, such that the images are assigned more accurate tags.

For example, the quality score associated with the first image may increase or decrease by a second metric score (e.g., the second metric score may be about 5 to about 10) proportionally for each tag assigned to the first image that is comprised within the first search. For example, the tag quality rating of an image may increase as a number of tags in common with terms in a search are increased. For example, where there are three tags, (e.g., dog, garden, and day) and all three are comprised within the first search (e.g., dog in a garden on a sunny day), the quality score associated with the first image may increase by about 15 to about 30, where each accurate tag comprises an increase of about 5 to about 10.

For example, where there are three tags, (e.g., garden, flower, and cat) and two are comprised within the first search (e.g., garden with flowers), the quality score associated with the first image may increase by about 5 to about 10, where each accurate tag comprises an increase of about 5 to about 10, and each inaccurate tag comprises a decrease of about 5 to about 10. In another example, the quality score associated with the first image may be assigned by the owner and/or operator of the webpage.

In an example, the quality score associated with the first image may be increased by a third metric score (e.g., the third metric score may be between about 10 to about 20) based upon the first search comprising the first tag. The quality score associated with the first image may be increased by about double, (e.g., about 20 to about 30) based upon the first search comprising the first tag and a second tag and the first image being associated with the first tag and the second tag. For example, where the first image is associated with the first subject matter (e.g., the first image depicts furniture) and a second subject matter (e.g., the first image also depicts a baby), the first tag comprises furniture, the second tag comprises baby, and the first search comprises baby on furniture. The quality score associated with the first image may be increased by about triple, (e.g., about 30 to about 40) based upon the first search comprising the first tag, the second tag, and a third tag and the first image being associated with the first tag, the second tag, and the third tag. For example, the first tag comprises dog, the second tag comprises sunglasses, the third tag comprises surfboard, and the first search comprises dog on a surfboard wearing sunglasses.

In an example, the quality metric may comprise rating a price of an image, such as at least one of the first image or the second image. The rating of the price may be determined by a price detector. The price detector may comprise a mechanism to assign a price score to images based upon a price that an image has been sold for versus a maximum price for similar images. For example, if the first image has been sold for one hundred dollars and the maximum price for similar images is one hundred and fifty dollars, the price score associated with the first image may be reduced proportionally to the difference between the maximum price for similar images and the price of the first image (e.g. the price score may be reduced by about one third). In another example, if the first image has been sold for one hundred dollars and the maximum price for similar images one hundred dollars, the price score associated with the first image may be increased (e.g., to a relatively high score assigned on a price ranking scale). In an example, the price ranking scale may be assigned by the owner and/or operator of the webpage.

For example, the quality score associated with the first image may increase or decrease by a fourth metric score (e.g., the fourth metric score may be about 0 to about 1) proportionally with the price rating of the first image (e.g. where the maximum price for similar images is twice that of the price that the first image is sold for, the price score may be increased by about 0.5). In an example, the quality score, derived from the price ranking, may be assigned by the owner and/or operator of the webpage.

In an example, the quality metric may comprise sponsorship of an image, such as at least one of the first image or the second image. The owner and/or operator of the webpage may offer a sponsorship option to an owner of an image and/or a user who uploads an image. For example, the owner of an image and/or the user who uploads the image, may pay a fee to the owner and/or operator of the webpage to have the image sponsored. For example, where the first image is sponsored, the quality score of the first image may increase by a fifth metric score (e.g., the fifth metric score may be about 8 to about 12) per dollar spent to acquire sponsorship based upon the first image being sponsored. In another example, the quality score, derived from sponsorship, of the first image may be increased by a value assigned by the owner and/or operator of the webpage.

In an example, the quality metric may comprise a time elapsed from receipt of at least one of the first image or the second image to a current time (e.g., which may indicate a staleness or freshness of an image). In an example, the first image may receive an initial value of 5 on a first day that the first image is received. The quality score associated with the first image may be reduced by 1 for each day elapsed between the date of receipt and the current time for five days. In an example, where two days have elapsed between the date the first image was received and the current time, the quality score associated with the first image may be reduced by 1 for each day that has passed, such that the quality score associated with the first image is reduced by 2. In an example, after five days have elapsed between the date that the first image was received and the current time, the quality score associated with the time elapsed between the receipt of the first image and the current time may no longer be reduced. In an example, the quality score, derived from the time elapsed, associated with the first image may be increased and/or decreased by a value assigned by the owner and/or operator of the webpage.

At 412, at least one of the first rank or the second rank may be altered based on the quality score. A highest quality score may result in a highest rank, a second highest quality score may result in a second highest rank, etc. For example, if the first image has the highest quality score, the first rank may be the highest rank image (e.g., the first image is presented in a most prominent location of a search results page). For example, if the second image has the second highest quality score, the second rank may be the second highest rank (e.g., the second image is presented in a second most prominent location of the search results page). At 414, the method ends.

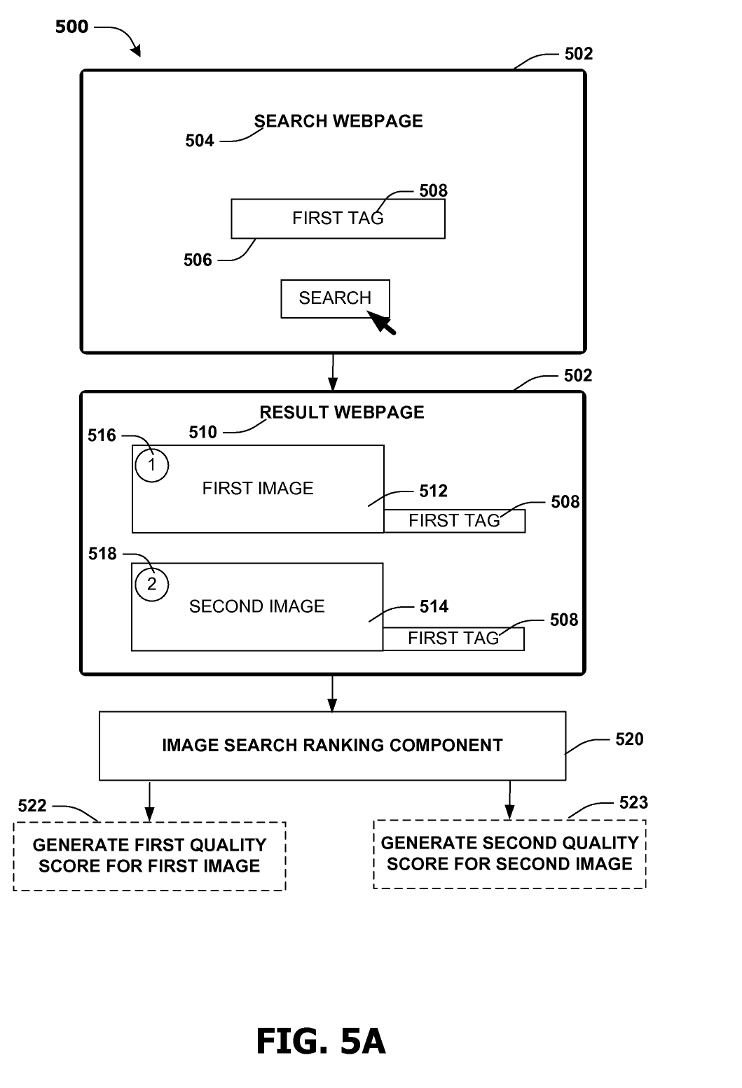

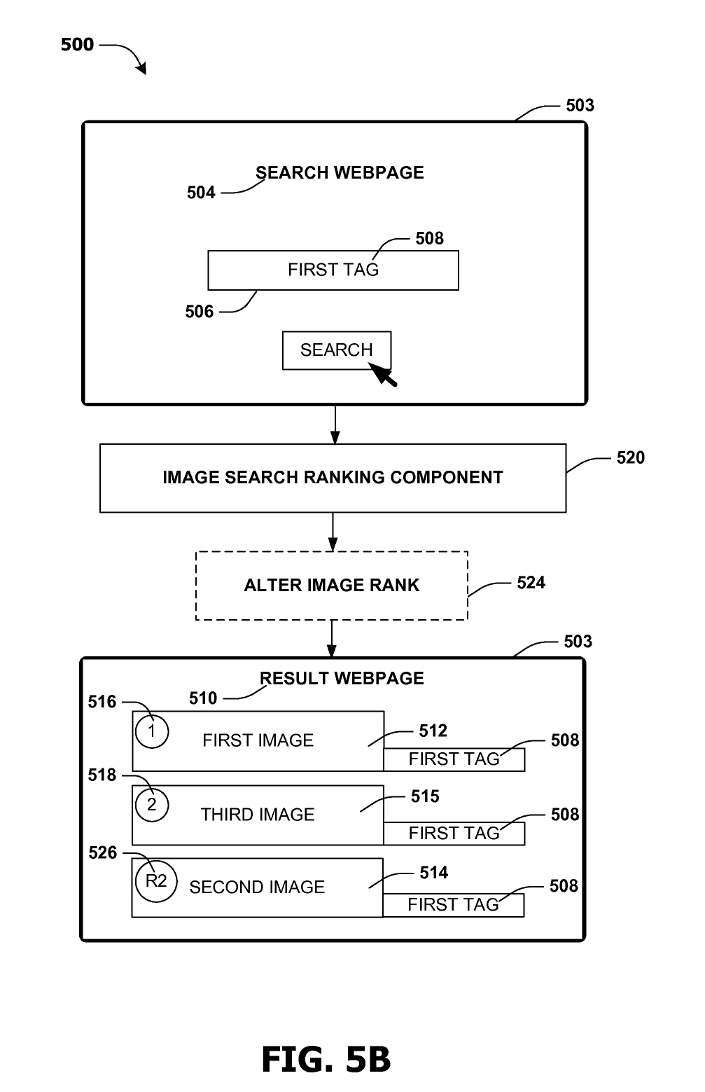

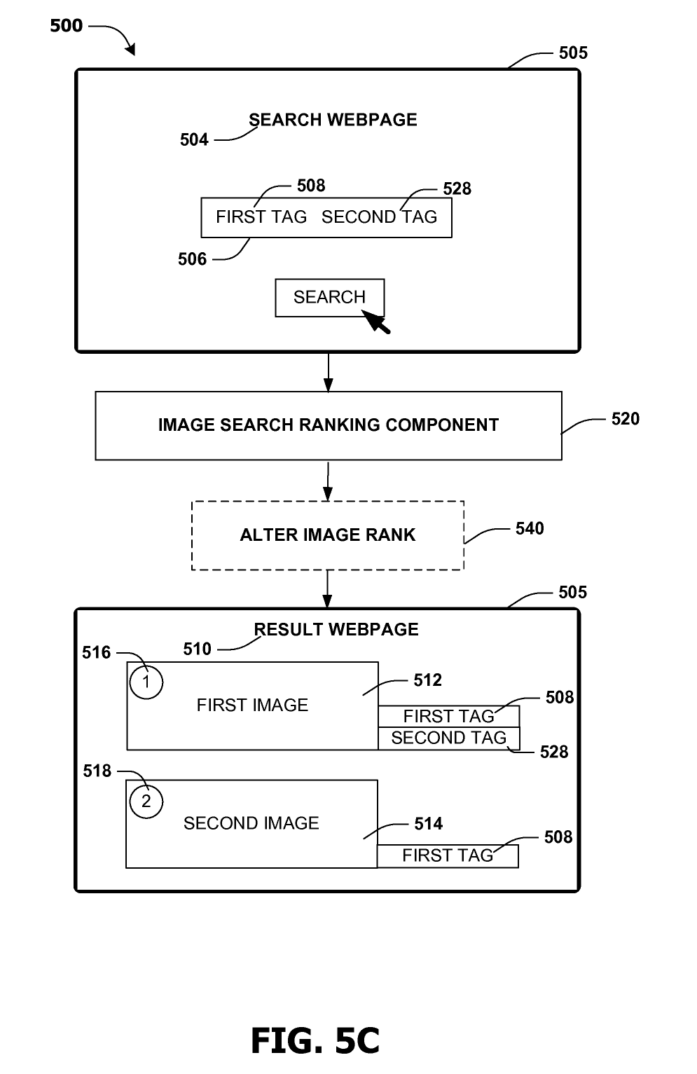

FIGS. 5A-5C illustrate a system 500, comprising an image search ranking component 520 for automated image ranking. FIG. 5A illustrates the image search ranking component 520 determining a quality score of an image. A user on a client device 502 may input a first search into a search box 506 of a search webpage 504. The first search may comprise a first tag 508. Responsive to the user initiating the first search, the image search ranking component 520 may rank at least one of a first image 512 associated with the first tag 508 and/or a second image 514 associated with the first tag 508 based upon a similarity of the first tag 508 to the first search. A website may display a result webpage 510. The result webpage 510 may display the first image 512 and the second image 514 on the client device 502. In an example, the first image 512, having been assigned a first rank 516, may be displayed in a first space (e.g., a most prominent location) on a display of the client device 502. In an example, the second image 514, having been assigned a second rank 518, may be displayed in a second space (e.g., a second most prominent location) on the display of the client device 502.

The image search ranking component 520 may receive user behavior from the client device 502. Responsive to the user behavior, a first quality score 522 may be generated for the first image 512 and/or a second quality score 523 may be generated for the second image 514. The first quality score 522 may be based on the user behavior associated with the first image 512 and/or a quality metric associated with the first image 512 and/or the second image 514. The second quality score 523 may be based on the user behavior associated with the second image 514 or the quality metric. The quality metric may be determined by an algorithm employed by the website displaying the result webpage 510. The user behavior may comprise at least one of a selection of the first image, a purchase of the first image, a rating of the first image, an identification of the first image as inappropriate, or an identification of the first image as offensive. The user behavior may be assigned a value associated with at least one of the first image 512 or the second image 514, which is used to generate the quality score as described with regard to 410 of FIG. 4, above. The quality metric may be comprise by at least one of a photo quality rating, a tag quality, a price, a sponsorship, or a proprietary metric of at least one of the first image 512 or the second image 514. The quality metric may be comprise a time elapsed from receipt of at least one of the first image 512 or the second image 514 to a current time. The quality metric may be used to generate the quality score as described with regard to 410 of FIG. 4, above.

FIG. 5B illustrates the image search ranking component 520 altering 524 an image rank of the first image 512 and/or the second image 514 based on the first quality score 522 and/or the second quality score 523. A first user on a first client device 503 may input a second search into the search box 506 of the search webpage 504. The first user and the user maybe the same or different users. The first client device 503 and the client device 502 may be the same or different client devices. The second search may comprise the first tag 508. The image search ranking component 520 may compare the first quality score 522 of the first image 512 to the second quality score 523 of the second image 514. Responsive to the user initiating the second search, the website may display the result webpage 510. The result webpage 510 may display the first image 512 and/or the second image 514 having the altered image rank 524. In an example, the second image 514 may be reduced to a reduced second rank 526 based upon the altering 524, such that a third image 515 associated with the first tag 508 has a third quality score higher than the second quality score. In an example, the third image 515 may be assigned the second rank 518. In an example, an image having been assigned a rank that is lower than a threshold may not be provided to the first user on the first client device 503.

FIG. 5C illustrates the image search ranking component 520 altering 540 the image rank 524 of the first image 512 and/or the second image 514 based on the first quality score 522 and/or the second quality score 523. A second user on a second client device 505 may input a third search into the search box 506 of the search webpage 504. The second user, the user, and the first user may be the same or different users. The second client device 505, the client device 502, and the first client device 503 may be the same or different client devices. The third search may comprise the first tag 508 and a second tag 528. The image search ranking component 520 may compare the first quality score 522 of the first image 512, associated with the first tag 508 and the second tag 528, to the second quality score 523 of the second image 514, associated with the first tag 508. The image search ranking component 520 may alter the image rank 524 of the first image 512 relative to the second image 514, because the first image 512 is associated with both the first tag 508 and the second tag 528, and the second image 514 is associated with merely the first tag 508 and not the second tag 528. Responsive to the user initiating the third search, the website may display the result webpage 510 comprising images ordered based upon the altered 540 image ranks. In an example, the result webpage 510 displays the first image, associated with the first tag 508 and the second tag 528, according to the first rank 516 and displays the second image 514, associated with the first tag 508, according to the second rank 518. For example, the first quality score may be higher than the second quality score, because the first image 512 has two associated tags that match the terms in the third search, while the second image 514 has one associated tag that matches the terms of the third search.

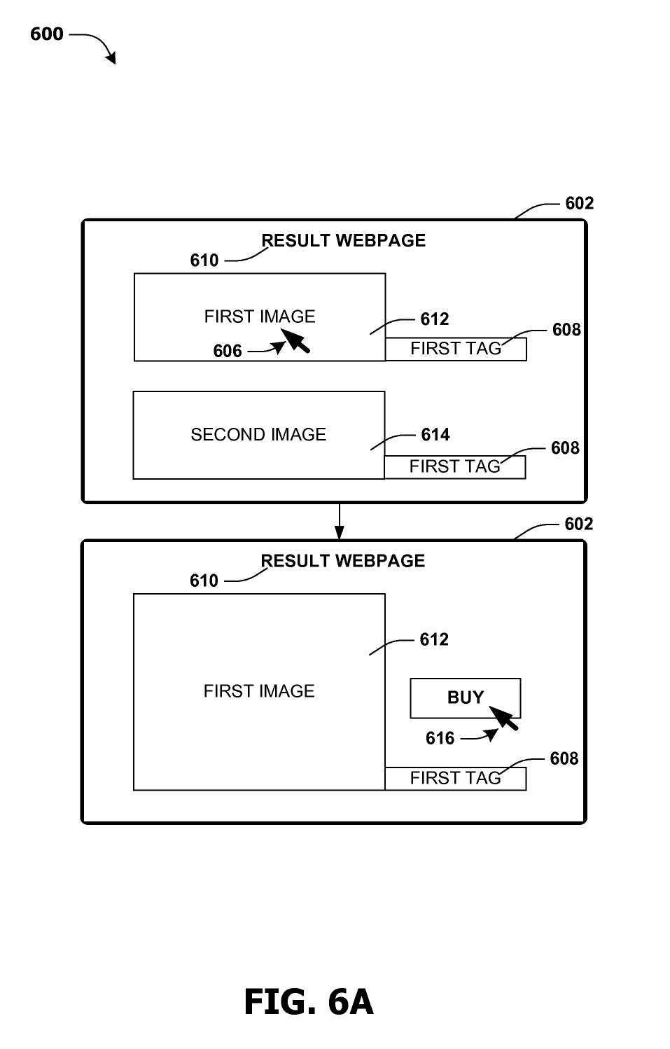

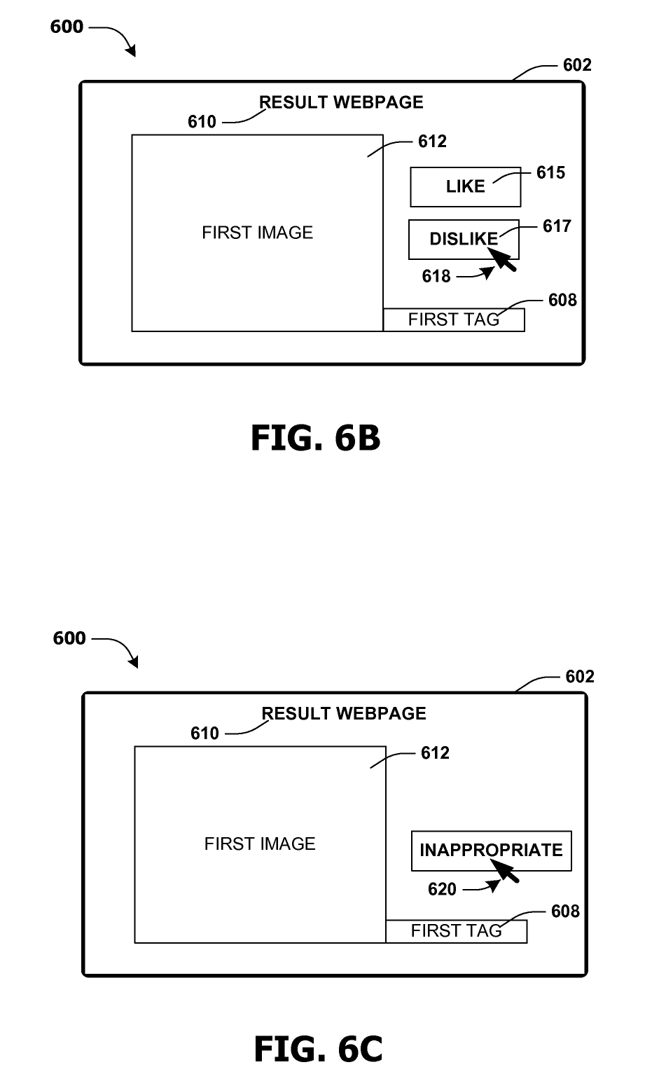

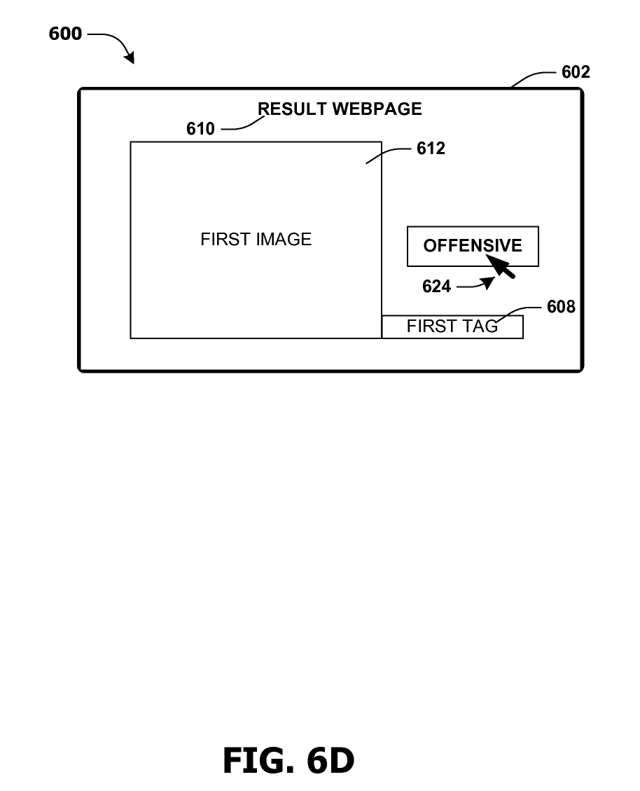

FIGS. 6A-6D illustrate a system 600, comprising examples of user behavior. FIG. 6A illustrates an example of user behavior comprising a user selecting 606 a first image 612 and/or purchasing 616 the first image 612. The user on a client device 602 may input a first search into a search box of a search webpage. The first search may comprise a first tag 608. Responsive to the user initiating the first search, the first image 612 associated with the first tag 608 and/or a second image 614, associated with the first tag 608, may be presented on a result webpage 610 on the client device 602, based upon a similarity of the first tag 608 to the first search.

In an example, the user behavior may comprise the user on the client device 602 selecting 606 the first image 612. The selecting 606 of the first image 612 (e.g., enlarging the first image 612, directing a cursor over the first image 612 and clicking, etc.) may increase the quality score of the first image. For example, the quality score associated with the first image 612 may increase by a first threshold amount (e.g., 10%) responsive to the selection of the first image 612. In an example, the quality score associated with selecting 606 the first image 612 may be assigned by the owner and/or operator of the result webpage 610.

In an example, the user behavior may comprise the purchase 616 of the first image 612 by the user on the client device 602. In an example, the user may select an icon stating buy or purchase. The purchase 616 of the first image 612 may increase the quality score of the first image 612. For example, the quality score associated with the first image 612 may increase by a second threshold amount (e.g., 60%) responsive to the purchase 616 of the first image 612. In an example, the quality score associated with the purchase 606 of the first image 612 may be assigned by the owner and/or operator of the result webpage 610.

FIG. 6B illustrates an example of user behavior comprising a user rating 618 the first image 612. In an example, the result webpage 610 displays a mechanism for rating 618 the first image 612. The mechanism for rating 618 comprises presenting a like option 615 and/or a dislike option 617 to the user. In an example, the user behavior comprises rating 618 the first image 612.

A positive rating (e.g., selecting the like option 615, a thumbs up icon, etc.) may contribute to an interestingness score. The interestingness score may comprise a measure that assesses a relative importance of a statistical result. The interestingness score may comprise a standardized value that allows different statistical results (e.g., a number of positive and/or negative comments about the first image 612, a number of discussions about the first image 612, etc.) to be compared on one scale. In an example, the interestingness score may comprise a scale from 0 to 1, or any other scale. The positive rating may be selected by the user to indicate a positive response. The positive rating may be integrated into the interestingness score. For example, the quality score associated with the first image 612 may increase by about 0.8 to about 1.2 on a scale of 0 to 20 responsive to the interestingness score being over 0.5. In an example, the quality score associated with the first image 612 may increase by about 8 to about 10 on a scale of 0 to 20 responsive to the positive rating, where the positive rating is generated on a secondary website.

A negative rating may comprise an interestingness score under about 0.5 (e.g., selecting the dislike option 617, a thumbs down icon, etc.). The dislike option 617 may be selected by the user to indicate a negative response. The negative rating may be integrated into the interestingness score. For example, the quality score associated with the first image 612 may decreased by about 0.8 to about 1.2 on a scale of 0 to 20 responsive to the interestingness score being below about 0.5. For example, the quality score associated with the first image 612 may decrease by about 8 to about 10 a scale of 0 to 20 responsive to the negative rating, where the negative rating is generated on the secondary website. In another example, the quality score associated with the negative rating and/or the positive rating may be assigned by the owner and/or operator of the webpage.

FIG. 6C illustrates an example of user behavior, comprising a user identification 620 of the first image 612 as inappropriate. In an example, the result webpage 610 may display a mechanism for identification 620 of the first image 612 as inappropriate. In an example, the user behavior may comprise the identification 620 of the first image 612 as inappropriate by the user on the client device. The identification 620 of the first image 612 as inappropriate may decrease the quality score of the first image 612. For example, the quality score associated with the first image 612 may decrease by about 8 to about 12 on a scale of 0 to 20 responsive to the identification 620 of the first image 612 as inappropriate. The user may be limited to the identification 620 of one image, or any number of images, as inappropriate per day. In an example, the quality score associated with the identification 620 of the first image 612 as inappropriate may be assigned by the owner and/or operator of the result webpage 610.

FIG. 6D illustrates an example of user behavior, comprising user identification 624 of the first image 612 as offensive. In an example, the result webpage 610 may display a mechanism for identification 624 of the first image 612 as offensive. In an example, the user behavior may comprise the identification 624 of the first image as offensive by the user on the client device. The identification 624 of the first image 612 as offensive may decrease the quality score of the first image 612. For example, the quality score associated with the first image 612 may decrease by about 0 to about 5 on a scale of 0 to 20 responsive to the identification 624 of the first image 612 as offensive. In an example, the quality score associated with the identification 624 of the first image 612 as offensive may be assigned by the owner and/or operator of the result webpage 610.

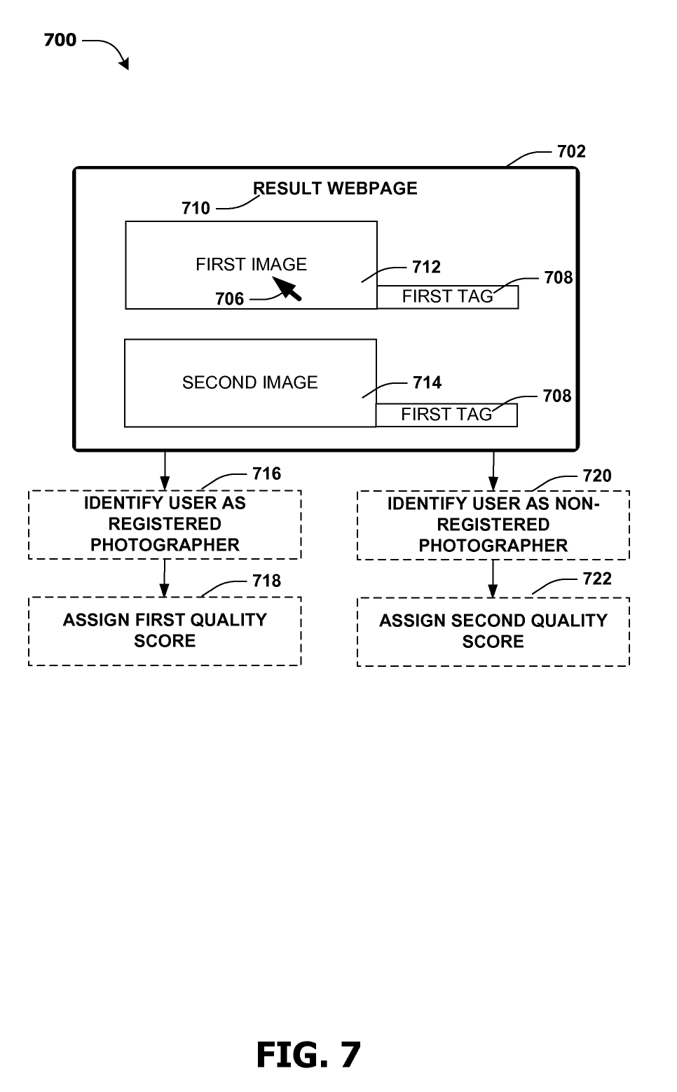

FIG. 7 illustrates an example of user behavior where a user is at least one of a registered photographer 716 or not a registered photographer 720. The user on a client device 702 may input a first search into a search box of a search webpage of a website. The first search may comprise a first tag 708. Responsive to the user initiating the first search, at least one of a first image 712, associated with the first tag 708, or a second image 714, associated with the first tag 708, may be presented on a result webpage 710 on the client device 702, based upon a similarity of the first tag 708 to the first search. The user may be a member of the website or may have a client identification that the website recognizes. For example, the user may register as a photographer. In an example where the user is identified as the registered photographer 716, a quality score associated with user actions may be higher than where the user is identified as not a registered photographer 720. Responsive to the user being identified as the registered photographer 716, a first quality score may be assigned to the first image 712, as described above with regard to FIG. 5A. Responsive to the user not being a registered photographer 720, a second quality score 722 may be assigned to the first image 712, as described above with regard to FIG. 5A. The first quality score, generated through the user behavior of the registered photographer 716, may be higher than the second quality score, generated through the user behavior of the user that is not a registered photographer 720.

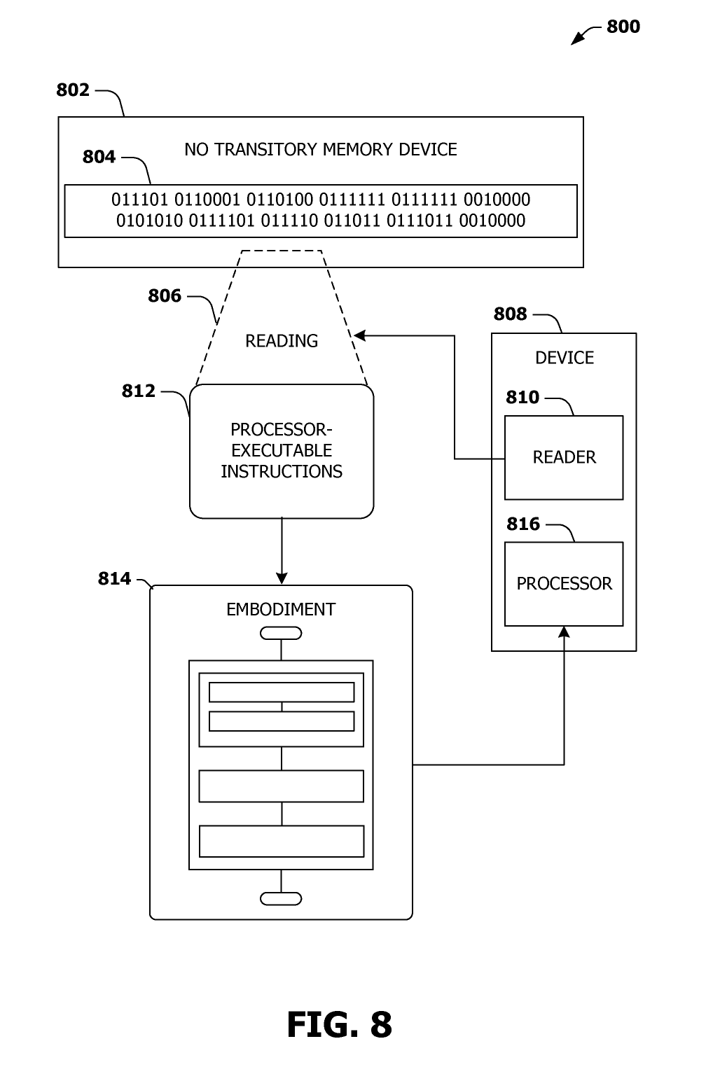

FIG. 8 is an illustration of a scenario 800 involving an example nontransitory memory device 802. The nontransitory memory device 802 may comprise instructions that when executed perform at least some of the provisions herein. The nontransitory memory device 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD, DVD, or floppy disk). The example nontransitory memory device 802 stores computer-readable data 804 that, when subjected to reading 806 by a reader 810 of a device 808 (e.g., a read head of a hard disk drive, or a read operation invoked on a solid-state storage device), express processor-executable instructions 812. In some embodiments, the processor-executable instructions, when executed on a processor 816 of the device 808, are configured to perform a method, such as at least some of the example method 400 of FIG. 4, for example. In some embodiments, the processor-executable instructions, when executed on the processor 816 of the device 808, are configured to implement a system, such as at least some of the example system 500 of FIGS. 5A-5C, at least some of the example system 600 of FIGS. 6A-6D, and/or at least some of the example system 700 of FIG. 7, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of ranking images, comprising:
assigning a first rank to a first image associated with a first tag;
assigning a second rank to a second image associated with the first tag;
responsive to receiving a first search from a client device, providing the first image and the second image to the client device based upon the first search corresponding to the first tag;
generating a quality score for at least one of the first image or the second image based upon at least one of a user behavior or a quality metric; and
altering at least one of the first rank or the second rank based upon the quality score.

2. The method of claim 1, comprising:
identifying a first subject matter of the first image;
designating the first tag as associated with the first image, the first tag associated with the first subject matter; and
assigning the first tag to the first image.

3. The method of claim 1, comprising:
responsive to determining the quality score of the first image, altering the ranking of the first image relative to the second image.

4. The method of claim 1, the altering comprising:
reducing the second image to a reduced second rank, and
responsive to receiving a second search, providing the first image based upon the first rank, but not the second image based upon the reduced second rank, as search results for the second search based upon the first search corresponding to the first tag.

5. The method of claim 1, comprising:
responsive to receiving a third search associated with the first tag and a second tag, increasing the first rank of the first image relative to the second rank of the second image based upon the first image being associated with the first tag and the second tag and the second image being associated with the first tag but not the second tag.

6. The method of claim 1, the user behavior comprising at least one of:
a selection of the first image;
a purchase of the first image;
a rating of the first image;
an identification of the first image as inappropriate; or
an identification of the first image as offensive.

7. The method of claim 1, comprising:
identifying a user associated with the client device;
responsive to the user being a registered photographer, assigning a first quality score to the first image; and
responsive to the user not being a registered photographer, assigning a second quality score to the first image, the first quality score higher than the second quality score.

8. The method of claim 1, the determining a quality metric comprising:
determining at least one of a photo quality rating, a tag quality, a price, a sponsorship, a proprietary metric, or a time elapsed from receipt of at least one of the first image or the second image as the quality metric.

9. The method of claim 1, comprising:
generating a first automatic tag for the first image based upon content of the first image; and
augmenting the first tag based upon the first automatic tag.

10. The method of claim 1, comprising:
responsive to the quality score corresponding to the second image and not the first image, increasing or decreasing the second rank.

11. A system for image search ranking, comprising:
an image search ranking component configured to:
assign a first rank to a first image associated with a first tag;
assign a second rank to a second image associated with the first tag;
responsive to receiving a first search from a client device, provide the first image and the second image to the client device based upon the first search corresponding to the first tag;
determine a quality score associated with the first image based upon at least one of a user behavior associated with the first image or a quality metric associated with the first image; and
alter the first rank based upon the quality score.

12. The system of claim 11, the image search ranking component configured to:
identify a first subject matter of the first image;
designate the first tag as associated with the first image, the first tag associated with the first subject matter; and
assign the first tag to the first image.

13. The system of claim 11, the image search ranking component configured:
reduce the second rank to a reduced second rank, and
responsive to receiving a second search, provide the first image based upon the first rank, but not the second image based upon the reduced second rank, as search results for the second search based upon the first search corresponding to the first tag.

14. The system of claim 11, the image search ranking component configured to:
responsive to receiving a third search associated with the first tag and a second tag, increase the first rank of the first image relative to the second rank of the second image based upon the first image being associated with the first tag and the second tag and the second image being associated with the first tag but not the second tag.

15. The system of claim 11, the image search ranking component configured to:
identify the user behavior based upon at least one of:
a selection of the first image;
a purchase of the first image;
a rating of the first image;
a bookmark of the first image;
an identification of the first image as inappropriate; or
an identification of the first image as offensive.

16. The system of claim 11, the image search ranking component configured to:
determine at least one of a photo quality rating, a tag quality, a price, a sponsorship, a proprietary metric, or a time elapsed from receipt of at least one of the first image or the second image as the quality metric.

17. The system of claim 11, the image search ranking component configured to:
responsive to the quality score corresponding to the second image and not the first image, increase or decrease the first rank.

18. A non-transitory computer readable medium comprising computer executable instructions that when executed by a processor perform a method for ranking images, comprising:
ranking a first image in relation to a second image, the ranking comprising:
responsive to receiving a first search corresponding to a first tag from a client device, providing:
a first image associated with the first tag, the first image having a first rank in relation to the client device; and
a second image associated with the first tag, the second image having a second rank in relation to the client device;
generating a quality score based upon at least one of a user behavior or a quality metric; and
altering at least one of the first rank or the second rank based upon the quality score.

19. The method of claim 18, comprising at least one of:
assigning the first tag to the first image comprising:
identifying a first subject matter of the first image;
designating the first tag as being associated with the first image, the first tag associated with the first subject matter; and
assigning the first tag to the first image; or
assigning a second tag to the first image comprising:
identifying a second subject matter of the first image;
designating a second tag as being associated with the first image, the second tag associated with the second subject matter; and
assigning the second tag to the first image.

20. The method of claim 18, the generating a quality score comprising at least one of:
scoring the user behavior, the user behavior comprising at least one of:
a selection of the first image;
a purchase of the first image;
a rating the first image;
an identification of the first image as inappropriate; or
an identification of the first image as offensive; or
scoring the quality metric, the quality metric based upon at least one of:
a photo quality rating of at least one of the first image or the second image;
a tag quality of at least one of the first image or the second image;
a price of at least one of the first image or the second image;
a sponsorship of at least one of the first image or the second image;
a proprietary metric of at least one of the first image or the second image; or
a time elapsed from receipt of at least one of the first image or the second image to a current time.
